(19) United States
(12) Patent Application Publication
(10) Pub. No.: US 2024/0017363 A1
(43) Pub. Date: Jan. 18, 2024

(54) CUTTER BENDING ANGLE DETECTION DEVICE, CUTTER BENDING MACHINE, AND CUTTER BENDING ANGLE DETECTION METHOD

(71) Applicant: DONGGUAN CITY YISONG HIGH TECHNOLOGY CO., LTD.,, Dongguan (CN)

(72) Inventor: Yihui CHI, Dongguan (CN)

(73) Assignee: DONGGUAN CITY YISONG HIGH TECHNOLOGY CO., LTD.,, Dongguan (CN)

(21) Appl. No.: 18/221,414

(22) Filed: Jul. 13, 2023

(30) Foreign Application Priority Data
Jul. 14, 2022 (CN) 202210823485.9

(51) Int. Cl. B23P 15/24; B26D 7/20; G01B 5/24

(52) U.S. Cl. CPC B23P 15/24; B26D 7/20; G01B 5/24

(57) ABSTRACT

A cutter bending angle detection device includes: a positioning member configured to position a straight segment of a cutter for facilitating the measurement of an angle between the straight segment and a bent segment of the cutter; a detection assembly, where a head end of the detection assembly is fixed to and rotatable with a rotating shaft of a servo motor, and the detection assembly is rotatable to contact with a wall surface of the bent segment; and a lifting device, where the positioning member and the detection assembly are provided on a lifting base of the lifting device and driven by the lifting device to rise or lower. A cutter bending machine and a cutter bending angle detection method are provided. The cutter bending angle device can quickly and accurately detect whether a bending angle of the cutter is satisfactory, and feed an error of compensation accuracy.

### CROSS REFERENCE TO THE RELATED APPLICATIONS

This application is based upon and claims priority to Chinese Patent Application No. 202210823485.9, filed on Jul. 14, 2022, the entire contents of which are incorporated herein by reference.

### TECHNICAL FIELD

The present disclosure relates to the field of cutter processing, and in particular to a cutter bending angle detection device, a cutter bending machine, and a cutter bending angle detection method.

### BACKGROUND

Currently, the die cutting process commonly used in the industry involves a cutter being mounted in the cutter groove of a die board for die cutting. The size of the cutter groove in the die board must be compatible with the cutter to prevent the cutter mounted in the cutter groove from falling off, shaking, etc., thereby avoiding affecting the quality of die cutting.

Due to the different shapes of different materials and products, the cutter groove and the cutter may be curved and angled, rather than long-striped and straight. In the industry, mounting the cutter into the cutter groove requires a specialized mounting worker with extensive experience, rather than an ordinary worker. The bending angle of cutters formed by commonly used cutter bending machines on the market often deviates from the design angle. To mount the cutter into the cutter groove, the mounting worker needs to manually adjust the bending angle of the cutter multiple times based on experience until the bending angle of the cutter is matched with the cutter groove. This process is often time-consuming and labor-intensive, affecting the normal progress of production.

In view of this, it is necessary to develop a cutter bending angle detection device, a cutter bending machine with a function of cutter bending angle detection based on the cutter bending angle detection device, and a cutter bending angle detection method based on the cutter bending angle detection device and the cutter bending machine.

### SUMMARY

In order to resolve most if not all of the above technical problems, the present disclosure provides a cutter bending angle detection device, a cutter bending machine, and a cutter bending angle detection method.

An embodiment in a first aspect of the present disclosure provides a cutter bending angle detection device, including:
a positioning member, where the positioning member is configured to position a straight segment of a cutter for facilitating the measurement of an angle between the straight segment and a bent segment of the cutter;
a detection assembly, where the detection assembly is provided above or below the positioning member and rotatable to contact with a wall surface of the bent segment; and
a lifting device, where the positioning member and the detection assembly are provided on a lifting base of the lifting device and driven by the lifting device to rise or lower.

As a further improvement of the present disclosure, the detection assembly includes:
a servo motor, where the servo motor is rotated to drive the detection assembly to rotate, and a bending angle of the cutter is calculated through a rotation angle of the servo motor;
a detection swing arm, where a head end of the detection swing arm is fixed to a rotating shaft of the servo motor; and
a detection probe, where the detection probe is provided on the detection swing arm, and after the detection swing arm swings, the detection probe contacts with the wall surface of the bent segment.

As a further improvement of the present disclosure, the positioning member includes:
a positioning member body, where a head end of the positioning member body is fixed to the lifting device, and a tail end of the positioning member body is provided with two sides formed into inclined planes towards a central position; and
a positioning groove, where the positioning groove is located at a top of the positioning member body and runs through left and right end surfaces, and a width of the positioning groove is matched with a thickness of the cutter.

As a further improvement of the present disclosure, the lifting device includes:
a lifting support;
a lifting power assembly, where the lifting power assembly is fixed to one end of the lifting support; and
the lifting base, where the lifting base is vertically movable on the lifting support, and an output end of the lifting power assembly is fixedly connected to the lifting base.

As a further improvement of the present disclosure, the lifting base is provided with an avoidance position; the servo motor is fixed below the lifting base, and the rotating shaft is located in the avoidance position; the positioning member is fixed above the lifting base; and when a bending position of the cutter is tightly attached to a right end surface of the positioning groove, the bending position of the cutter is located on a central axis of the rotating shaft.

As a further improvement of the present disclosure, a top of a tail end of the detection swing arm is provided with a standing post, and the detection probe is provided on the standing post.

A cutter bending machine includes:
a bending device, where the bending device is configured to bend a long-striped and straight cutter at a set angle;
a cutting device, where the cutting device is configured to cut a bent cutter from the long-striped cutter; and
the above-mentioned cutter bending angle detection device.

The cutter bending angle detection device is liftably provided between the bending device and the cutting device.

As a further improvement of the present disclosure, a bending die of the bending device is provided with a bending groove for inserting the cutter; the cutting device is provided with a fixing groove for fixing the cutter; and when the bending die is not rotated for bending, the bending groove, the positioning groove, and the fixing groove are located on a same plane.

A cutter bending angle detection method includes the following steps:
setting a torque limit value of a servo motor; and stopping the servo motor when a detection probe contacts with a wall surface of a cutter and the torque limit value is reached;
rotating the servo motor before the cutter is bent, and allowing the detection probe to contact with the cutter, where the detection probe is subjected to a resistance from the cutter and acts on the servo motor; stopping a rotation of the servo motor when a torque of the servo motor reaches the set torque limit value of the servo motor; and denoting a contact position between the detection probe and the cutter as a position 1, and recording a rotation angle W1 of the servo motor relative to a zero position;
rotating the servo motor after the cutter is bent according to a set bending angle, and allowing the detection probe to contact with a bent segment of the cutter, where a bending position of the cutter is located on a central axis of a rotating shaft of the servo motor; stopping the rotation of the servo motor when the torque of the servo motor reaches the torque limit value; and denoting a contact position between the detection probe and the bent segment of the cutter as a position 2, and recording a rotation angle W2 of the servo motor relative to the zero position; and
calculating an actual bending angle of the cutter according to equations: bending angle A=W2−W1, and bending supplementary angle B=180−(W2−W1); determining whether the actual ending angle of the cutter is satisfactory; and if the actual bending angle is too small or too large, feeding a difference back to a cutter bending machine, and performing a secondary bending until the actual bending angle is satisfactory.

As a further improvement of the present disclosure, the cutter bending angle detection method includes: conveying a bent cutter towards a cutting device; driving, by a lifting power assembly, a lifting base to rise; avoiding the bent segment, and allowing a straight segment to fall into a positioning groove for positioning; and driving, by the lifting power assembly, the lifting base to lower after a bending angle of the cutter is measured, such that the cutter is disengaged from the positioning groove and continuously conveyed towards the cutting device.

The embodiments of the present disclosure have the following technical effects. The present disclosure achieves a reasonable and ingenious structure. The torque limit value of the servo motor is set to avoid an excessive external force on the cutter causing deformation and affecting the accuracy of monitoring data. When the detection probe contacts with the cutter and the torque limit value is reached, the servo motor stops rotating. The encoder integrated with the servo motor provides feeds the rotation angle and other parameters of the servo motor back to the upper computer in real time. The feedback is sensitive, fast, and high-precision. The cutter bending machine calculates the bending angle of the cutter based on the rotation angle. If the bending angle is not matched with the set bending angle, that is, if the bending angle is too large or too small, the difference is compensated to the bending angle of the cutter bending machine. The bending device is controlled to bend according to the adjusted parameter, such that the bending angle of the cutter meets a set requirement, reducing the requirement for adjusting the bending angle of the cutter in a subsequent cutter mounting process. In this way, the dependence on specialized mounting workers is reduced, and ordinary workers can also meet the requirements of cutter mounting, thereby reducing labor costs, shortening the mounting time, and reducing production costs.

The present disclosure is described in further detail below with reference to the drawings and embodiments.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show merely some embodiments of the present disclosure, and those of ordinary skill in the art may still derive other drawings from these drawings without creative efforts.

FIG. 1 is a three-dimensional structural diagram of a cutter bending angle detection device according to the present disclosure;

FIG. 2 is a structural diagram of a cutter bending machine according to the present disclosure;

FIG. 3 is a top view of a straight cutter according to the present disclosure;

FIG. 4 is a top view of a bent cutter according to the present disclosure;

FIG. 5 is a schematic diagram of detection according to the present disclosure;

FIG. 6 is a structural diagram of a positioning member according to the present disclosure;

FIG. 7 is a structural diagram of a detection assembly according to the present disclosure; and

FIG. 8 is a structural diagram of a lifting device according to the present disclosure.

### DETAILED DESCRIPTION OF THE EMBODIMENTS

To make the above objectives, features and advantages of the present application more comprehensible, the specific implementations of the present application are described in detail below with reference to the drawings. Many details are provided in the following description in order for a thorough understanding of the present application. However, the present application may be implemented in many other ways other than those described herein, and those skilled in the art may make similar improvements without departing from the connotation of the present application. Therefore, the present application is not limited to the specific embodiments disclosed below.

In the description of the present application, it needs to be understood the orientation or positional relationships indicated by terms, such as “up”, “down”, “front”, “rear”, “left”, “right”, “vertical”, “horizontal”, “top”, “bottom”, “inside”, and “outside”, are based on the orientation or positional relationship shown in the drawings, are merely for facilitating the description of the present application and simplifying the description, rather than indicating or implying that an apparatus or element referred to must have a particular orientation or be constructed and operated in a particular orientation, and therefore will not be interpreted as limiting the present application.

In the description of this application, it should be understood that terms such as “first” and “second” are used merely for a descriptive purpose, and should not be construed as indicating or implying a relative importance, or implicitly indicating the number of indicated technical features. Therefore, a feature limited by “first” or “second” may explicitly or implicitly include at least one such feature. In the description of the present disclosure, “a plurality of” means at least two, such as two or three, unless otherwise clearly and specifically limited.

In the description of the embodiments of the present disclosure, unless otherwise clearly specified and defined, the technical terms such as “mounting”, “interconnection”, “connection” and “fixation” should be understood in a broad sense. For example, the “connection” may be a fixed connection, removable connection or integral connection; may be a mechanical connection or electrical connection; may be a direct connection or indirect connection through a medium; and may be a communication or interaction between two elements. Those of ordinary skill in the art may understand specific meanings of the above terms in the embodiments of the present disclosure based on a specific situation.

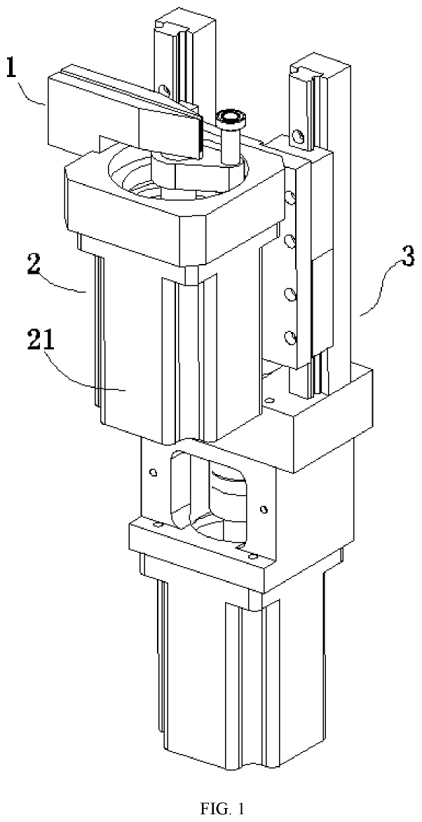

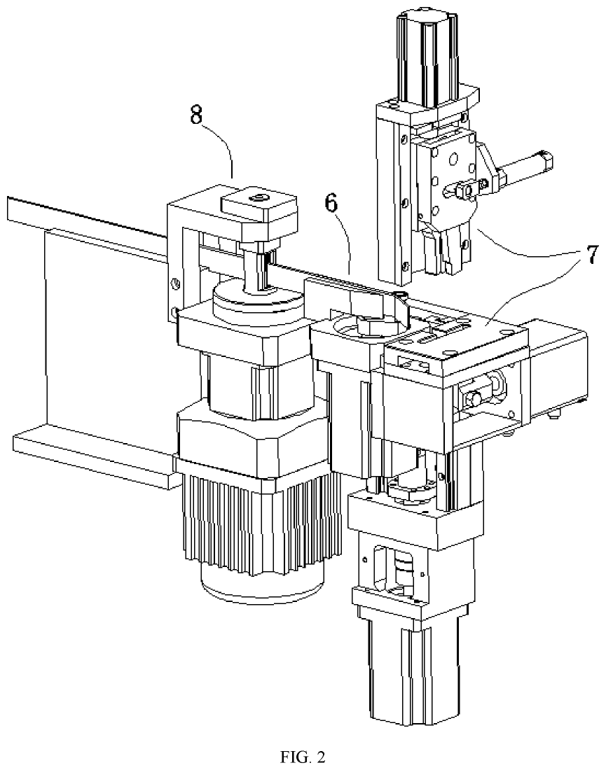

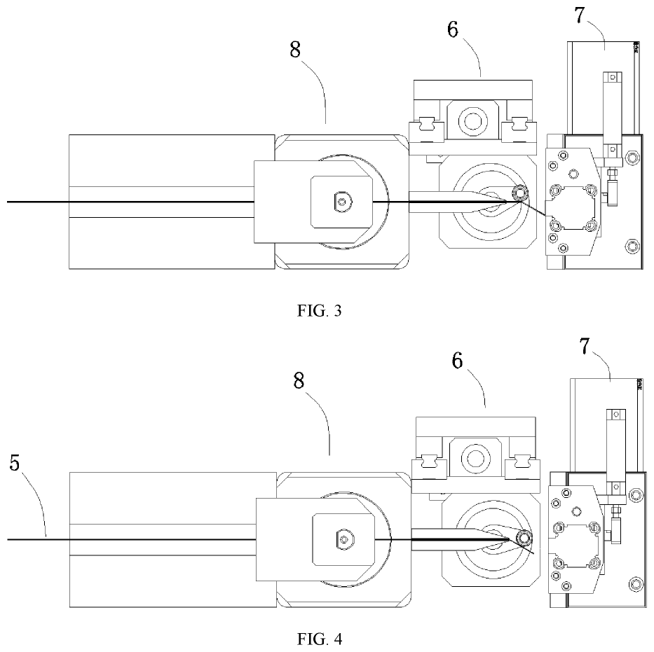

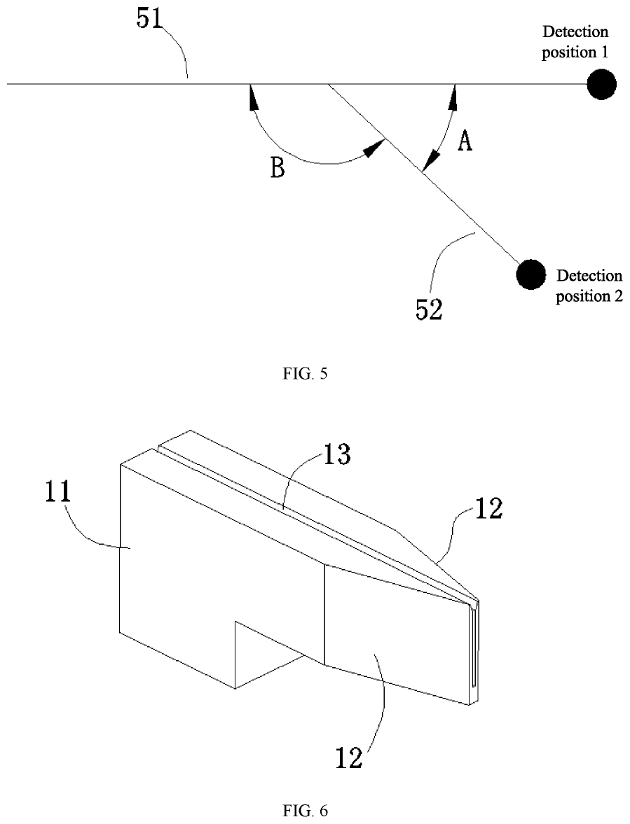

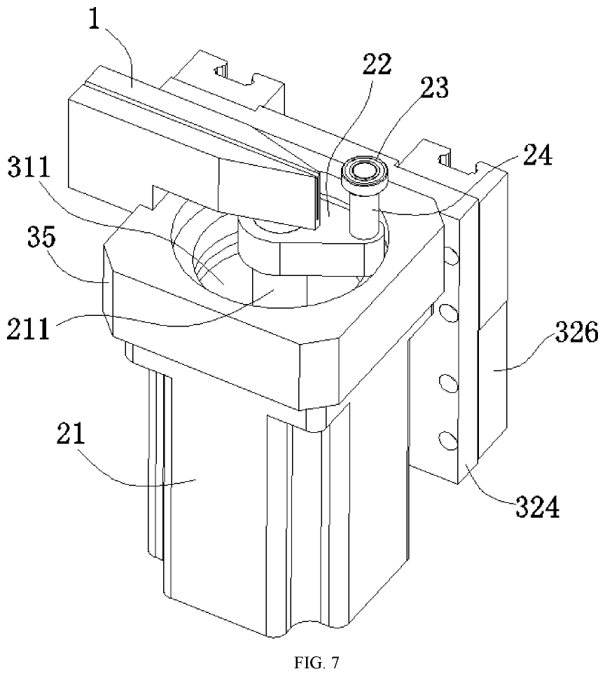

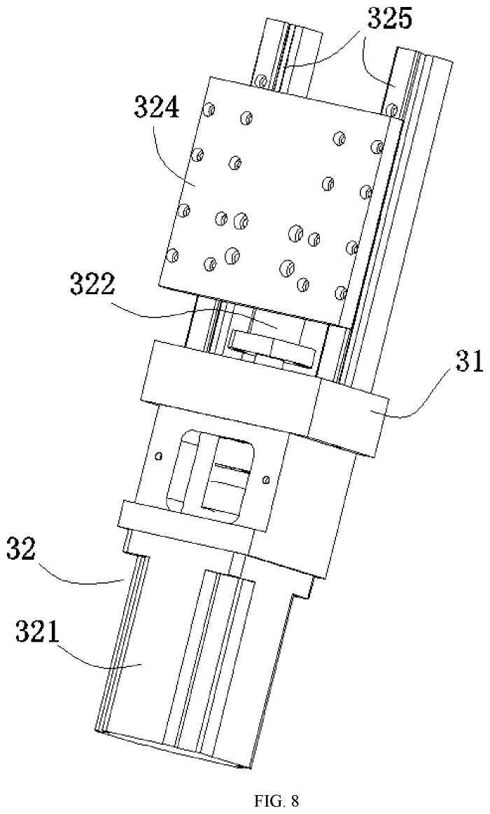

As shown in FIGS. 1 to 8, an embodiment of a first aspect of the present disclosure provides a cutter bending angle detection device, including: positioning member 1, detection assembly 2, and lifting device 3.

The positioning member 1 is configured to position straight segment 51 of cutter 5 for facilitating the measurement of an angle between the straight segment and bent segment 52 of the cutter.

The detection assembly 2 is provided above or below the positioning member 1, and is rotatable to contact with a wall surface of the bent segment. In this embodiment, the detection assembly 2 is located below the positioning member 1.

The positioning member 1 and detection assembly 2 are provided on lifting base 35 of the lifting device 3 and driven by the lifting device 3 to rise or lower.

As a further improvement of the present disclosure, the detection assembly 2 includes servo motor 21, detection swing arm 22, and detection probe 23.

The servo motor 21 is rotated to drive the detection assembly 2 to rotate, and a bending angle of the cutter is calculated through a rotation angle of the servo motor 21.

The servo motor 21 is integrated with or separated from an encoder. The encoder is configured to acquire and feed the rotation angle and other parameter of the servo motor 21 acquired during bending angle detection back to an upper computer. It is determined whether the bending angle of the cutter is satisfactory. If the bending angle of the cutter is not satisfactory, a difference is calculated. According to the difference, a bending device is controlled to adjust the bending angle, so as to accurately bend the cutter.

The upper computer can be a separately added microcontroller or other control chip, and can be a built-in control system of a cutter bending machine. In the present disclosure, the cutter bending angle detection device can be used as a separate device for detecting the bending angle of the cutter, or can be integrated into the bending device to form a cutter bending machine.

In other embodiments, the servo motor can be a hollow cup motor with low internal structural friction and fast motion speed.

A head end of the detection swing arm 22 is fixed to rotating shaft 211 of the servo motor 21.

The detection probe 23 is provided on the detection swing arm 22. After the detection swing arm 22 swings, the detection probe 23 contacts with the wall surface of the bent segment.

When the cutter is placed in the positioning groove, it can be located above or below the detection swing arm 22. When the detection swing arm 22 swings, the cutter does not contact the detection swing arm 22. In this embodiment, the cutter is located above the detection swing arm 22. The detection probe 23 can be fixed to a top, a side wall, or an end of the detection swing arm 22. However, a portion of the detection probe 23 is located at a same horizontal height as the cutter, ensuring the contact between the cutter and the detection probe 23 when the detection swing arm 22 swings.

In this embodiment, the detection probe 23 can be a cylinder or a sphere.

As a further improvement of the present disclosure, the positioning member 1 includes: positioning member body 11 and positioning groove 13.

A head end of the positioning member body 11 is fixed to the lifting device 3, and a tail end of the positioning member body 11 is provided with two sides formed into inclined planes 12 towards a central position. Due to the inclined planes 12 on the two sides of the tail end of the positioning member body 11, a tip is formed, thereby reducing a volume of the positioning member body 11. This design facilitates mounting in a limited space of the cutter bending machine, achieving automated assembly line operations such as cutter bending, online angle detection, and cutting, and improving production efficiency.

The positioning groove 13 is located at a top of the positioning member body 11 and runs through left and right end surfaces. A width of the positioning groove 13 is matched with a thickness of the cutter. Due to the width of the positioning groove 13 matched with the thickness of the cutter, the cutter provided in the positioning groove 13 will not shake, improving the accuracy of angle detection.

In the detection of the bending angle of the cutter, the straight segment 51 of the cutter is provided in the positioning groove 13, and the bent segment 52 of the cutter is located at a right end of the positioning groove 13. A bending position of the cutter overlaps with a central axis of the rotating shaft 211 of the servo motor 21. In some embodiments, one end of the straight segment 51 of the cutter can extend out of a left end of the positioning groove 13 and extend all the way into a bending die of the bending device. In other embodiments, one end of the straight segment 51 of the cutter can be located in the positioning groove 13.

As a further improvement of the present disclosure, the lifting device 3 includes: lifting support 31, lifting power assembly 32, and lifting base 35.

The lifting power assembly 32 is fixed to one end of the lifting support 31. The lifting power assembly 32 can be a motor transmission structure, a cylinder transmission structure, etc. In the present disclosure, the lifting power assembly 32 includes lifting motor 321 and screw rod 322 connected to the rotating shaft 211 of the lifting motor 321. The screw rod 322 is provided with a rotating member that is matched with a thread of the screw rod 322. The rotating member is fixedly connected to the lifting base 35 through mounting plate 324. The lifting motor 321 is fixed to the lifting support 31. The lifting support 31 is further provided with guide rail 325. The mounting plate 324 is provided with slider 326 that is matched with the guide rail 325.

The lifting base 35 is vertically movable on the lifting support 31, and an output end of the lifting power assembly 32 is fixedly connected to the lifting base 35. As a further improvement of the present disclosure, the lifting base 35 is provided with an avoidance position. The servo motor 21 is fixed below the lifting base 35, and the rotating shaft 211 is located in the avoidance position. The positioning member 1 is fixed above the lifting base 35. When the bending position of the cutter is tightly attached to a right end surface of the positioning groove 13, the bending position of the cutter is located on the central axis of the rotating shaft 211.

The lifting base 35 is a square block. A lower surface of the lifting base 35 is provided with multiple hole positions for fixing the servo motor 21. The avoidance position 311 is a circular through-hole, and two ends of the circular through-hole are respectively provided with countersunk holes. In this embodiment, all the detection swing arm 22 or a lower part thereof is provided in the avoidance position 311, further reducing a space occupied by the cutter bending angle detection device.

As a further improvement of the present disclosure, a top of a tail end of the detection swing arm 22 is provided with standing post 24, and the detection probe 23 is provided on the standing post 24. The detection probe 23 can be fixedly or flexibly connected to the standing post 24. The detection probe 23 overlaps with a central axis of standing post 24, and is rotatable.

A cutter bending machine includes: bending device 8, cutting device 7, and cutter bending angle detection device 6.

The bending device 8 is configured to bend a long-striped and straight cutter at a set angle.

The cutting device 7 is configured to cut a bent cutter from the long-striped cutter.

The cutter bending angle detection device 6 is the above-mentioned cutter bending angle detection device.

The cutter bending angle detection device 6 is liftably provided between the bending device 8 and the cutting device 7.

The bending device 8 and the cutting device 7 are available in the prior art. The bending device 8 bends the cutter at a set angle through a bending die.

The cutter bending angle detection device 6 detects the bending angle. If the detected bending angle is not matched with a set angle, the parameter is fed back to the upper computer to adjust the bending angle of the bending device 8, so as to form a qualified cutter. If the detected bending angle is matched with the set angle, the cutting device 7 cuts the bent cutter according to a set length.

As a further improvement of the present disclosure, the bending die of the bending device 8 is provided with a bending groove for inserting the cutter. The cutting device 7 is provided with a fixing groove for fixing the cutter. When the bending die is not rotated for bending, the bending groove, the positioning groove 13, and the fixing groove are located on a same plane.

A cutter bending angle detection method includes the following steps.

A torque limit value of servo motor 21 is set. When detection probe 23 contacts with a wall surface of a cutter and the torque limit value is reached, the servo motor 21 stops rotating.

Before the cutter is bent, the servo motor 21 is rotated, and the detection probe 23 contacts with the cutter. The detection probe 23 is subjected to a resistance from the cutter and acts on the servo motor 21. When a torque of the servo motor 21 reaches the set torque limit value of the servo motor 21, the servo motor 21 stops rotating. A contact position between the detection probe 23 and the cutter is denoted position 1, and rotation angle W1 of the servo motor 21 relative to a zero position is recorded.

After the cutter is bent according to a set bending angle, the servo motor 21 rotates and the detection probe 23 contacts with a bent segment of the cutter. A bending position of the cutter is located on a central axis of rotating shaft 211 of the servo motor 21. When the torque of the servo motor 21 reaches the torque limit value, the servo motor stops rotating. A contact position between the detection probe 23 and the bent segment of the cutter is denoted position 2, and rotation angle W2 of the servo motor 21 relative to the zero position is recorded.

An actual bending angle of the cutter is calculated according to equations: bending angle A=W2−W1, and bending supplementary angle B=180−(W2−W1). It is determined whether the actual ending angle of the cutter is satisfactory. If the actual bending angle is too small or too large, a difference is fed back to a cutter bending machine, and a secondary bending is performed until the actual bending angle is satisfactory.

The servo motor 21 runs in a speed (torque) mode, and an appropriate torque limit value is set to control the start and stop of the servo motor 21. When the detection probe 23 rotates in the speed mode, if there is no external force and a real-time torque of the servo motor 21 does not reach the set torque limit value, the servo motor 21 continues to rotate. If an obstacle applies an external force to the detection probe 23 and the real-time torque of the servo motor 21 reaches the set torque limit value, the servo motor 21 stops rotating.

The torque limit value of the servo motor 21 is set. When the detection probe 23 contacts with the wall surface of the cutter and the torque limit value is reached, the servo motor 21 stops rotating.

As shown in FIG. 5, the bent cutter is regarded as an obstacle that applies an external force to the servo motor 21. Before bending, the cutter (straight) contacts with the detection probe 23 to stop the servo motor. An actual position of the servo motor 21 is denoted as position 1 (at an angle relative to the zero position of the servo motor), and the rotation angle of the servo motor 21 is denoted as W1. After bending, the cutter (bent) contacts with the detection probe 23 to stop the servo motor. An actual position of the motor is denoted as position 2 (at an angle relative to the zero position of the servo motor), and the rotation angle of the servo motor 21 is denoted as W2. The bending angle of the cutter is calculated based on the position 1 and the position 2. That is, the actual bending angle of the cutter is calculated according to the equations: bending angle A=W2−W1, and bending supplementary angle B=180−(W2−W1).

In the detection method, the torque of the servo motor 21 is easy to control and adjust, with a large control range and high accuracy.

The servo motor and an encoder are integrated, with a high feedback accuracy. The detection method avoids the problem of low motor response speed, as the feedback position is acquired until the servo motor is completely stopped due to the external force.

The setting of the torque limit value is crucial, and the torque limit value is usually 0.06 N (±10 N). The servo motor needs to overcome its own friction force in case there is no external force (usually the friction force of the rotating shaft is very small), and to avoid plastic deformation after contacting with the obstacle. 0.06 N (±0.05 N) is a preferred torque limit value in this embodiment.

As a further improvement of the present disclosure, after bending, the cutter is conveyed towards cutting device 7. Lifting power assembly 32 drives lifting base 35 to rise, avoiding the bent segment and allowing a straight segment 51 to fall into positioning groove 13 for positioning. After a bending angle of the cutter is measured, the lifting power assembly 32 drives the lifting base 35 to lower, and the cutter is disengaged from the positioning groove 13 and continuously conveyed towards the cutting device 7.

The present disclosure achieves a reasonable and ingenious structure. The torque limit value of the servo motor 21 is set to avoid an excessive external force on the cutter causing deformation and affecting the accuracy of monitoring data. When the detection probe 23 contacts with the cutter and the torque limit value is reached, the servo motor 21 stops rotating. The encoder integrated with the servo motor 21 provides feeds the rotation angle and other parameters of the servo motor 21 back to the upper computer in real time. The feedback is sensitive, fast, and high-precision. The cutter bending machine calculates the bending angle of the cutter based on the rotation angle. If the bending angle is not matched with the set bending angle, that is, if the bending angle is too large or too small, the difference is compensated to the bending angle of the cutter bending machine. The bending device 8 is controlled to bend according to the adjusted parameter, such that the bending angle of the cutter meets a set requirement, reducing the requirement for adjusting the bending angle of the cutter in a subsequent cutter mounting process. In this way, the dependence on specialized mounting workers is reduced, and ordinary workers can also meet the requirements of cutter mounting, thereby reducing labor costs, shortening the mounting time, and reducing production costs.

The above described are merely preferred embodiments of the present disclosure rather than limitations on the present disclosure in any form. The methods and technical content disclosed above may be used by any person skilled in the art to make many possible variations and modifications to the technical solutions of the present application or modify them into equivalent embodiments of equivalent variations, without departing from the scope of the technical solutions of the present application. Therefore, equivalent changes made according to the shape, structure, and principle of the present disclosure without departing from the content of the technical solutions of the present disclosure should be included in the protection scope of the present disclosure.

What is claimed is:

1. A cutter bending angle detection device, comprising:
a positioning member, wherein the positioning member is configured to position a straight segment of a cutter for facilitating a measurement of an angle between the straight segment and a bent segment of the cutter;
a detection assembly, wherein the detection assembly is provided above or below the positioning member and rotatable to contact with a wall surface of the bent segment; and
a lifting device, wherein the positioning member and the detection assembly are provided on a lifting base of the lifting device and driven by the lifting device to rise or lower.

2. The cutter bending angle detection device according to claim 1, wherein the detection assembly comprises:
a servo motor, wherein the servo motor is rotated to drive the detection assembly to rotate, and a bending angle of the cutter is calculated through a rotation angle of the servo motor;
a detection swing arm, wherein a head end of the detection swing arm is fixed to a rotating shaft of the servo motor; and
a detection probe, wherein the detection probe is provided on the detection swing arm, and after the detection swing arm swings, the detection probe contacts with the wall surface of the bent segment.

3. The cutter bending angle detection device according to claim 2, wherein the positioning member comprises:
a positioning member body, wherein a head end of the positioning member body is fixed to the lifting device, and a tail end of the positioning member body is provided with two sides formed into inclined planes towards a central position; and
a positioning groove, wherein the positioning groove is located at a top of the positioning member body and runs through left and right end surfaces of the positioning member body, and a width of the positioning groove is matched with a thickness of the cutter.

4. The cutter bending angle detection device according to claim 3, wherein the lifting device comprises:
a lifting support;
a lifting power assembly, wherein the lifting power assembly is fixed to one end of the lifting support; and
the lifting base, wherein the lifting base is vertically movable on the lifting support, and an output end of the lifting power assembly is fixedly connected to the lifting base.

5. The cutter bending angle detection device according to claim 3, wherein the lifting base is provided with an avoidance position; the servo motor is fixed below the lifting base, and the rotating shaft is located in the avoidance position; the positioning member is fixed above the lifting base; and when a bending position of the cutter is tightly attached to a right end surface of the positioning groove, the bending position of the cutter is located on a central axis of the rotating shaft.

6. The cutter bending angle detection device according to claim 5, wherein a top of a tail end of the detection swing arm is provided with a standing post, and the detection probe is provided on the standing post.

7. A cutter bending machine, comprising:
a bending device, wherein the bending device is configured to bend a long-striped and straight cutter at a set angle to obtain a bent cutter;
a cutting device, wherein the cutting device is configured to cut the bent cutter from the long-striped and straight cutter; and
the cutter bending angle detection device according to claim 1;
wherein the cutter bending angle detection device is liftably provided between the bending device and the cutting device.

8. The cutter bending machine according to claim 7, wherein a bending die of the bending device is provided with a bending groove for inserting the cutter; the cutting device is provided with a fixing groove for fixing the cutter; and when the bending die is not rotated for bending, the bending groove, the positioning groove, and the fixing groove are located on a same plane.

9. A cutter bending angle detection method, comprising the following steps:
rotating a servo motor before a cutter is bent, and allowing a detection probe to contact with the cutter, wherein the detection probe is subjected to a resistance from the cutter and acts on the servo motor; stopping a rotation of the servo motor when a torque of the servo motor reaches a set torque limit value of the servo motor; and denoting a contact position between the detection probe and the cutter as a position 1, and recording a first rotation angle W1 of the servo motor relative to a zero position;
rotating the servo motor after the cutter is bent according to a set bending angle, and allowing the detection probe to contact with a bent segment of the cutter, wherein a bending position of the cutter is located on a central axis of a rotating shaft of the servo motor; stopping the rotation of the servo motor when the torque of the servo motor reaches the set torque limit value; and denoting a contact position between the detection probe and the bent segment of the cutter as a position 2, and recording a second rotation angle W2 of the servo motor relative to the zero position; and
calculating an actual bending angle of the cutter according to equations: bending angle A=W2−W1, and bending supplementary angle B=180−(W2−W1); determining whether the actual ending angle of the cutter is satisfactory; and when the actual bending angle is too small or too large, feeding a difference back to a cutter bending machine, and performing a secondary bending until the actual bending angle is satisfactory.

10. The cutter bending angle detection method according to claim 9, further comprising: conveying a bent cutter towards a cutting device; driving, by a lifting power assembly, a lifting base to rise; avoiding the bent segment, and allowing a straight segment to fall into a positioning groove for positioning; and driving, by the lifting power assembly, the lifting base to lower after a bending angle of the cutter is measured, such that the cutter is disengaged from the positioning groove and continuously conveyed towards the cutting device.

11. The cutter bending machine according to claim 7, wherein the detection assembly comprises:
a servo motor, wherein the servo motor is rotated to drive the detection assembly to rotate, and a bending angle of the cutter is calculated through a rotation angle of the servo motor;
a detection swing arm, wherein a head end of the detection swing arm is fixed to a rotating shaft of the servo motor; and
a detection probe, wherein the detection probe is provided on the detection swing arm, and after the detection swing arm swings, the detection probe contacts with the wall surface of the bent segment.

12. The cutter bending machine according to claim 11, wherein the positioning member comprises:
a positioning member body, wherein a head end of the positioning member body is fixed to the lifting device, and a tail end of the positioning member body is provided with two sides formed into inclined planes towards a central position; and
a positioning groove, wherein the positioning groove is located at a top of the positioning member body and runs through left and right end surfaces of the positioning member body, and a width of the positioning groove is matched with a thickness of the cutter.

13. The cutter bending machine according to claim 12, wherein the lifting device comprises:
a lifting support;
a lifting power assembly, wherein the lifting power assembly is fixed to one end of the lifting support; and
the lifting base, wherein the lifting base is vertically movable on the lifting support, and an output end of the lifting power assembly is fixedly connected to the lifting base.

14. The cutter bending machine according to claim 12, wherein the lifting base is provided with an avoidance position; the servo motor is fixed below the lifting base, and the rotating shaft is located in the avoidance position; the positioning member is fixed above the lifting base; and when a bending position of the cutter is tightly attached to a right end surface of the positioning groove, the bending position of the cutter is located on a central axis of the rotating shaft.

15. The cutter bending machine according to claim 14, wherein a top of a tail end of the detection swing arm is provided with a standing post, and the detection probe is provided on the standing post.
